(19) United States
(12) Patent Application Publication
(10) Pub. No.: US 2026/0133988 A1
(43) Pub. Date: May 14, 2026

(54) CONTROLLING A DISTRIBUTION OF LEADER INSTANCES

(71) Applicant: International Business Machines Corporation, Armonk, NY (US)

(72) Inventors: Martin Henke, Reutlingen (DE); Fabian Sehm, Nienhagen (DE); Norman Christopher Böwing, Böblingen (DE); Alexander Potrykus, Chester (GB)

(21) Appl. No.: 19/181,877

(22) Filed: Apr. 17, 2025

(30) Foreign Application Priority Data
Nov. 7, 2024 (GB) 2416379.2

(51) Int. Cl. G06F 16/27

(52) U.S. Cl. CPC G06F 16/27

(57) ABSTRACT

The present disclosure relates to a method for controlling a distribution of leader instances of a distributed database system. The distributed database system includes a plurality of independent database instances implemented in a leader-follower configuration. The method includes a monitoring of load states of hosts and distributions of the database instances over the hosts. Using gathered metric values descriptive of the load states, it is checked, whether one of the load states of one of the hosts violates a predefined threshold. In response to detecting a violation of the predefined threshold, leader instances of the database instance running on the host with the load state violating the predefined threshold are identified. A switchover scheme, which defines a minimum number of one or more switchovers, for resolving the detected violation of the predefined threshold is determined and execution of the switchovers defined by the switchover is controlled.

### BACKGROUND

The present invention relates to the field of digital computer systems, and more specifically, to a method for controlling a distribution of leader instances of a distributed database system. The present invention further relates to a computer program product and a computing device for controlling the distribution of the leader instances of the distributed database system.

Modern database systems may be implemented as distributed database systems, which provide database services for multiple users or groups of users, e.g., in a multi-tenant environment. For different users or groups of users, independent database instances may be provided by the database system. However, managing multiple independent database instances on a distributed database system may be challenging.

### SUMMARY

Various embodiments provide a method for controlling a distribution of leader instances of a distributed database system using a leader distribution managing component, a computer program product for controlling a distribution of leader instances of a distributed database system using a leader distribution managing component, and a computing device for controlling a distribution of leader instances of a distributed database system using a leader distribution managing component as described by the subject matter of the independent claims. Advantageous embodiments are described in the dependent claims. Embodiments of the present invention can be freely combined if they are not mutually exclusive.

In one aspect, the invention relates to a method for controlling the distribution of leader instances of a distributed database system using a leader distribution managing component. The distributed database system is implemented on a plurality of hosts. The distributed database system includes a plurality of independent database instances. Each independent database instance of the plurality of independent database instances is implemented in a leader-follower configuration including one of the leader instances and one or more replica instances replicating the respective leader instance.

The method includes by the leader distribution managing component a monitoring of load states of hosts of the plurality of hosts and distributions of the plurality of independent database instances over the hosts of the plurality of hosts. The monitoring of the load states of the hosts includes gathering metric values descriptive of the respective load states. Using the gathered metric values, it is checked whether one of the load states of one of the hosts of the plurality of hosts violates a predefined threshold. In response to detecting a violation of the predefined threshold by one of the load states, leader instances of the plurality of independent database instances of the distributed database system running on a host with the load state violating the predefined threshold are identified. A switchover scheme to be used for resolving the detected violation of the predefined threshold is determined. The switchover scheme to be used defines a minimum number of one or more switchovers for the identified leader instances required for resolving the detected violation of the predefined threshold. Each switchover of the one or more switchovers defines for one of the identified leader instances a switching of a leader role of a respective identified leader instance to one of the one or more replica instances of the respective identified leader instance. An execution of the one or more switchovers defined by the switchover scheme to be used is controlled.

In another aspect, the invention relates to a computer program product for controlling a distribution of leader instances of a distributed database system using a leader distribution managing component. The distributed database system is implemented on a plurality of hosts. The distributed database system includes a plurality of independent database instances. Each independent database instance of the plurality of independent database instances is implemented in a leader-follower configuration including one of the leader instances and one or more replica instances replicating the respective leader instance.

The computer program product includes a non-transitory computer-readable storage medium having computer-readable program code embodied therewith. The program code is configured to implement the leader distribution managing component. Execution of the computer-readable program code by a processing unit of a computing device causes the leader distribution managing component to monitor load states of hosts of the plurality of hosts and distributions of the plurality of independent database instances over the hosts of the plurality of hosts. The monitoring of the load states of the hosts includes gathering metric values descriptive of the respective load states. Using the gathered metric values, it is checked whether one of the load states of one of the hosts of the plurality of hosts violates a predefined threshold. In response to detecting a violation of the predefined threshold by one of the load states, leader instances of the plurality of independent database instances of the distributed database system running on the host with the load state violating the predefined threshold are identified. A switchover scheme to be used for resolving the detected violation of the predefined threshold is determined. The switchover scheme to be used defines a minimum number of one or more switchovers for the identified leader instances required for resolving the detected violation of the predefined threshold. Each switchover of the one or more switchovers defines for one of the identified leader instances a switching of a leader role of a respective identified leader instance to one of the one or more replica instances of the respective identified leader instance. An execution of the one or more switchovers defined by the switchover scheme to be used is controlled.

In another aspect, the invention relates to a computing device for controlling a distribution of leader instances of a distributed database system using a leader distribution managing component. The distributed database system is implemented on a plurality of hosts. The distributed database system includes a plurality of independent database instances. Each independent database instance of the plurality of independent database instances is implemented in a leader-follower configuration including one of the leader instances and one or more replica instances replicating the respective leader instance.

The computing device includes a processing unit and a memory unit with computer-readable program code embodied therewith. The program code is configured to implement the leader distribution managing component. Execution of the computer-readable program code by the processing unit causes the leader distribution managing component to monitor load states of hosts of the plurality of hosts, and distributions of the plurality of independent database instances over the hosts of the plurality of hosts. The monitoring of the load states of the hosts includes gathering metric values descriptive of the respective load states. Using the gathered metric values, it is checked whether one of the load states of one of the hosts of the plurality of hosts violates a predefined threshold. In response to detecting a violation of the predefined threshold by one of the load states, leader instances of the plurality of independent database instances of the distributed database system running on the host with the load state violating the predefined threshold are identified. A switchover scheme to be used for resolving the detected violation of the predefined threshold is determined. The switchover scheme to be used defines a minimum number of one or more switchovers for the identified leader instances required for resolving the detected violation of the predefined threshold. Each switchover of the one or more switchovers defines for one of the identified leader instances a switching of a leader role of a respective identified leader instance to one of the one or more replica instances of the respective identified leader instance. An execution of the one or more switchovers defined by the switchover scheme to be used is controlled.

### BRIEF DESCRIPTION OF THE DRAWINGS

The following description will provide details of preferred embodiments with reference to the following figures wherein:

FIG. 1 is a flowchart of an exemplary method for controlling the distribution of leader instances of a distributed database system, in accordance with an embodiment of the disclosure.

FIG. 2 is a flowchart of an exemplary method for determining a switchover scheme to be used for resolving a detected violation of a predefined threshold, in accordance with an embodiment of the disclosure.

FIG. 3 is a flowchart of an exemplary method for an iterative resolving violations of predefined thresholds, in accordance with an embodiment of the disclosure.

FIG. 4 is a flowchart of an exemplary method for controlling the distribution of leader instances of a distributed database system, in accordance with an embodiment of the disclosure.

FIG. 5 is an exemplary distributed database implemented on a plurality of hosts, in accordance with an embodiment of the disclosure.

FIG. 6 is an exemplary computing environment for controlling a distribution of leader instances of a distributed database system, in accordance with an embodiment of the disclosure.

FIG. 7 is an exemplary cloud computing environment, in accordance with an embodiment of the disclosure.

FIG. 8 depicts exemplary abstraction model layers, in accordance with an embodiment of the disclosure.

### DETAILED DESCRIPTION

The descriptions of the various embodiments of the present invention will be presented for purposes of illustration but are not intended to be exhaustive or limited to the embodiments disclosed. Many modifications and variations will be apparent to those of ordinary skill in the art without departing from the scope and spirit of the embodiments described. The terminology used herein was chosen to best explain the principles of the embodiments, the practical application or technical improvement over technologies found in the marketplace, or to enable others of ordinary skill in the art to understand the embodiments disclosed herein.

Examples may provide a method for controlling the distribution of leader instances and replica instances of database instances of a distributed database system. The database instances may, e.g., be database instances in a multi-tenant environment. Using a leader distribution managing component with access to metric values descriptive of load states of hosts, on which the distributed database system with the database instances is implemented, the load states of the hosts may be monitored. In case a violation of a predefined threshold by one of the hosts is determined using the respective metric values, the leader distribution managing component may determine a switchover scheme to resolve the detected violation. Thus, a suboptimal load distribution over the hosts and in particular an overloading of individual hosts may be prevented. Thereby, potential problems and a loss of performance of the distributed database system resulting from an overloading of individual hosts may be prevented effectively.

The database instances may be implemented in a leader-follower configuration including a leader instance and one or more replica instances replicating the respective leader instance. The leader instance may be the one individual instance of a database instance responsible for processing write operations received from clients. It may also be responsible for propagating the write operations to the replication instances. For example, read request may only be served by the leader instance. According to an alternative implementation, read requests may be served by both the leader instances and replica instances. On receiving a written request from a client, the leader instance of a database instance, e.g., assigned to the respective client, may first update its local storage. It may then send an update request to its replica instances, which on receiving the update request from the leader instance may update their local storage.

Since the main workload in a leader-follower configuration is caused by the leader instance, the placement of leader instances on hosts of a distributed database system may be crucial for controlling the workload states of the individual hosts. Examples may have the beneficial effect, that the leader distribution managing component may effectively control the distribution of the leader instances on the hosts of a distributed database system.

For example, the gathered metric values may be used for checking whether any of the load states of any of the hosts of the plurality of hosts violates a predefined threshold of a set of thresholds. The set of thresholds may include a plurality of predefined thresholds. In case a violation of a plurality of predefined thresholds of the set of thresholds by a host is detected by the leader distribution managing component, the switchover scheme determined by the leader distribution managing component may be a switchover scheme to be used to resolve all of the violations of predefined thresholds by the respective host.

A predefined threshold may, e.g., be a threshold defined for metric values of a metric. Metric values larger or smaller than the respective threshold may violate the same, depending on whether it is an upper or lower threshold.

The monitoring of the distributions of the database instances may, e.g., include identifying for each of the database instances host locations of the leader instance and the one or more replica instances of the respective database instances. Thus, the leader distribution managing component may have an overview, where on the hosts of the plurality of hosts which leader and/or replica instances of which database instances are running,

Running the database system or more precisely, the database instances included by the database system in a leader-follower configuration may enable the provision of a highly available database systems.

Examples may provide beneficial effects for a database connection routing, also referred to as database connection pooling, which uses data of a distinct database instance, referred to as database cluster, to decide on which of the individual instances included by the database instance a database request is routed to. In an active-active configuration, in which all of the individual instances are equal, each of the individual instances may be chosen. However, in the leader-follower configuration, the leader instance of the respective database instance is targeted. Examples may enable a controlling of such leader instances and thereby a controlling of distribution of workloads over the distributed database system. Examples may be beneficial for usage in a multi-tenant environment, in particular in a multi-tenant cloud environment. In a multi-tenant cloud environment, a database system may provide a plurality of database instances for a plurality of tenants. Different database instances may be allocated for different tenants.

For a leader-follower configuration, the decision of which of the individual instances included by the database instances is the leader instance of the respective database instance may be taken by each database instance of the database system individually. This may lead to a suboptimal host placement of the leader instances when looking at a general load distribution of the database system, e.g., on a cloud system. This may even be the case if the database instances were initially distributed optimally. Examples suggest using a central leader distribution managing component, which is configured to acquire knowledge of load states of hosts, e.g., of a cloud system, and of distributions of a plurality of independent database instances of the distributed database system over the hosts, for distributing leader instances. Using a central leader distribution managing component may be advantageous compared to a selection of the leader instances by the single database instances of the database system, which may have no knowledge of each other and the overall plurality of hosts, e.g., provided by a cloud system. Examples may have the beneficial effect of avoiding getting into a suboptimal distribution of the leader instances. Such a suboptimal distribution may be a distribution, in which loads caused by the leader instances are unevenly distributed over the hosts. Thus, an individual host may be overloaded, i.e., their load states may violate a predefined threshold, resulting in problems and a loss of performance of the distributed database system.

The distributed database system may, e.g., be a database system which provides database services. The database services may, e.g., be provided as part of a cloud service.

Examples may have the beneficial effect of increasing fault tolerance of the database service provided by the database system. Examples may have the beneficial effect of reduced cost and/or resource consumption due to higher host utilization. Examples may have the beneficial effect of increasing customer satisfaction by enabling a provision of a database service with a more consistent performance and/or an increased reliability.

Examples may use a central leader distribution managing component, which is configured for controlling a placement leader instances on the hosts of the database system. The leader distribution managing component may be configured to control a switching of leader roles of leader instances of the database system to replica instances of the respective leader instances. The central leader distribution managing component may, e.g., be configured for using current metric values and/or expected metric values, resulting from one or more switchovers, to determine which database instance would benefit from selecting another leader instance.

For example, metric values are descriptive of load states of all hosts of the database system, e.g., implemented in the form of a cloud system. The metric values may, e.g., be descriptive of one or more host system specific characteristics of the load states of the hosts. The metric values may, e.g., be descriptive of one or more database instance specific characteristics of the load states of the hosts.

Examples may provide an enhanced switchover method, which may be tailored for a multi-tenant database hosting environment. This method may be executed by a leader distribution managing component that consumes metric values descriptive of host system specific, database instance, and/or network-specific characteristics of the load states of the hosts to optimize the distribution of leader instances and replica instances of the database instance across hosts. The method may, e.g., further be configurable through policies that consider factors such as customer importance, cost minimization, performance, uniform host distribution, and network utilization. Using the configured policy, the leader distribution managing component may, e.g., prioritize specific criteria for leader instance distribution and switchover decisions.

The leader distribution managing component may, e.g., be configured for using metric values to make switchover decisions. These switchover decisions may, e.g., be controlled by configured policies.

A database instance may include a leader instance and one or more replica instances that may, e.g., be distributed over multiple hosts.

A host may provide a runtime and resources for one or more database instances running on them. Hosts may, e.g., differ with respect to provided resources, e.g., in terms of a memory and/or a central processing unit.

Examples may include gathering metric values on all hosts and all database instances of the database system, e.g., metric values descriptive of one or more host system specific characteristics of the load states of the hosts as well as metric values descriptive of one or more database instance specific characteristics of the load states of the host. For each database instance, e.g., a host location of the leader instance as well as host locations of the replica instances may be determined.

The leader distribution managing component may, e.g., keep track of host memory size and/or CPU size, since utilization calculations may depend on these absolute values. The leader distribution managing component may continuously monitor hosts and database instances to assess whether predefined thresholds are violated. These thresholds may, e.g., be formulated as Boolean expressions using metric values of metrics accessible to the leader distribution managing component. Examples of such thresholds may, e.g., include 'Host CPU > 80%', 'Database number of connections > 100', 'Host Memory Size == 16Gi', or any valid combination thereof.

Upon detecting a violation of a threshold, the leader distribution managing component may endeavor to redistribute a minimum number of leader instances of the database instance to alleviate the breach. The objective may be to ensure that the threshold is no longer violated, thereby maintaining system stability and optimal performance. In the redistribution process, the leader distribution managing component may, e.g., evaluate metric values gathered from hosts running replica instances associated with each leader instance responsible for violating the predefined threshold, i.e., running on the host violating the predefined threshold. The leader distribution managing component may, e.g., conduct a fresh threshold assessment using recalculated updated metric values, that would arise from switchovers, i.e., appointing replica instances as updated leader instances of database instances. After computing this for all potential switchovers concerning the affected host and, e.g., taking into account other database constraints, the leader distribution managing component may, e.g., select an action requiring the fewest switchovers, i.e., a switchover scheme with a minimum number of switchovers to be used for resolving the detected violation of the predefined threshold.

Finally, the leader distribution managing component may trigger the necessary switchovers of the leader instances as calculated in the previous step and defined by the

For example, the metric values are descriptive of one or more host system specific characteristics of the load states of the hosts. Examples may have the beneficial effect that host system specific characteristics of the hosts may be used for determining a need for a switchover.

For example, the metric values quantify one or more of an available capacity of a central processing unit of a respective host or an available capacity of a memory of the respective host. The available capacity of the central processing unit (CPU) of the respective host may, e.g., be described by a utilization of the respective central processing unit. For determining the utilization of the respective central processing unit, the leader distribution managing component may, e.g., keep track of a host CPU size of the respective memory. The available capacity of the memory of the respective host may, e.g., be described by a utilization of the respective memory. For determining the utilization of the respective central processing unit, the leader distribution managing component may, e.g., keep track of a host memory size of the respective memory.

For example, the metric values are descriptive of one or more database instance specific characteristics of the load states of the hosts. Examples may have the beneficial effect that database instance specific characteristics may be used for determining a need for a switchover.

For example, the metric values describe one or more of a number of database connections assigned to the database instance running on the respective host, a response time for database operations of the database instance running on the respective host, a rate of input and output operations of the database instance running on the respective host, or a rate of database operations of the database instances running on the respective host.

A number of database connections assigned to the database instances running on the respective host may, e.g., include a total number of database connections (total_connections) of the respective host. The larger the number of database connections of database instances, e.g., of leader instances and/or replica instances, on a host, is, the higher a load caused by the respective database connections may be.

A response time for database operations of the database instances running on the respective host may, e.g., be a latency of a read and/or a write operation, in particular a mean latency (disk_read_latency_mean; disk_write_latency_mean). Latencies of read and/or write operations may be an indication of a load of host caused by database instances, e.g., leader instances and/or replica instances, running thereon. If latencies become too large, the efficiency of the distributed database may decrease.

A rate of input and output operations of the database instances running on the respective host may, e.g., be a total IOPS of read and write operation (disk_iops_read_write_total). Input/output operations per second (IOPS) is an input/output performance metric, which may be used to characterize computer storage.

A rate of database operations of the database instances running on the respective host may, e.g., be a database read or write rate, like a rate of fetched tuples (tuples_fetched_rate), a rate of inserted tuples (tuples_inserted_rate), and/or a rate of updated tuples (tuples_updated_rate). These rates may provide metrics describing rates of database operations, like a read (tuples_fetched_rate) or write (tuples_inserted_rate; tuples_updated_rate), on a database instance, e.g., a leader instance and/or replica instance.

For example, the switchover scheme to be used is determined to result in no violation of the predefined threshold by another load state of another host of the plurality of hosts. By determining, i.e., checking, that no violation of the predefined threshold and/or any other predefined threshold, in case of a set of thresholds, by another load state of another host of the plurality of hosts results from executing the switchover scheme to be used, it may be ensured that by executing the determined switchover scheme any violation of a predefined threshold may be prevented for the moment. Alternatively, an interactive approach may be used by determining after an execution of the switchover scheme to be used, whether any other violations of any other predefined threshold result from the execution. Resulting violations may be resolved iteratively on demand.

For example, the determining, that the switchover scheme to be used results in no violation of the predefined threshold by another load state of another host of the plurality of hosts, includes calculating expected metric values resulting from the switchovers of the switchover scheme to be used and checking that the expected metric values result in no violation of the predefined threshold by another load state of another host. Using the expected metric values, the leader distribution managing component may, e.g., be able to estimate the effect of switchovers defined by the switchover scheme. For calculating the expected metric values, the leader distribution managing component may use the gathered metric values and, e.g., apply an extrapolation and/or an interpolation to the same.

For example, the determination of the switchover scheme to be used includes successfully increasing a number of potential switchovers for the identified leader instances. For each number of potential switchovers, the method further includes determining a set of potential switchover schemes. The set of potential switchover schemes includes a potential switchover scheme for each combination of potential switchovers of the respective number of switchovers. For each potential switchover scheme of the set of potential switchover schemes, it is determined whether the potential switchovers of the respective potential switchover scheme resolve the detected violation of the predefined threshold. In response to determining that the potential switchovers of one of the potential switchover schemes resolve the detected violation of the predefined threshold, the respective potential switchover is selected as the switchover scheme to be used.

By successfully increasing the number of potential switchovers used for determining a switchover to be used for resolving the detected violation of the predefined threshold, it may be, e.g., be ensured that the determined includes a minimum number of switchovers required for resolving the violation.

For example, the determining, whether the potential switchovers of the potential switchover schemes resolve the detected violation of the predefined threshold includes calculating expected metric values resulting from the potential switchovers of the respective potential switchover scheme and checking, whether the expected metric values resolve the detected violation of the predefined threshold.

Using the expected metric values, the leader distribution managing component may, e.g., be able to estimate the effect of switchovers defined by the switchover scheme. For calculating the expected metric values, the leader distribution managing component may use the gathered metric values and, e.g., apply an extrapolation and/or an interpolation to the same.

For example, the method further includes, in response to the determination that the potential switchovers of one of the potential switchover schemes resolve the detected violation of the predefined threshold, stopping the increasing of the number of potential switchovers.

The potential switchovers for the identified leader instances may, e.g., be successfully increasing until either a switchover scheme resolving the detected violation of the predefined threshold is found or a maximum number of potential switchovers is reached without finding a switchover scheme resolving the detected violation. The maximum number of potential switchovers may be given by a total number of leader instances identified to run on the host violating the predefined threshold. If the maximum number of potential switchovers is reached without finding a switchover scheme to resolve the detected violation, i.e., if no suitable switchover scheme for resolving the detected violation of the predefined threshold is found, the determination of a switchover scheme may be terminated and the leader distribution managing component may, e.g., raise an out-of-capacity alert.

For example, the method further includes gathering updated metric values descriptive of updated load states of the hosts of the plurality of hosts resulting from the execution of the one or more switchovers defined by the switchover scheme to be used. Using the updated gathered metric values, it is checked whether another one of the updated load states of one of the hosts of the plurality of hosts violates the predefined threshold. In response to detecting a further violation of the predefined threshold by another one of the updated load states, further leader instances of the plurality of independent database instances of the distributed database system running on the host with the updated load states violating of the predefined threshold are identified. A further switchover scheme for resolving the detected further violation of the predefined threshold is determined. The further switchover scheme defines a minimum number of one or more further switchovers for the identified further leader instances required for resolving the detected further violation of the predefined threshold. Each switchover of the one or more further switchovers defines for one of the identified further leader instances a switching of a leader role of a respective identified further leader instance to one of the one or more replica instances of the respective identified further leader instance. An execution of the one or more further switchovers defined by the further switchover scheme is controlled.

Examples may enable an iterative resolving of violations of predefined thresholds. A given switchover scheme may be determined to resolve a detected violation of a predefined threshold. It may not be checked whether any other violations may result from executing the respective switchover scheme. It may be determined after an execution of the switchover scheme to be used, whether any other violations of any other predefined threshold result from the execution. Resulting violations may then be resolved iteratively if necessary.

For example, the determination of the switchover scheme to be used further includes, in response to determining a plurality of candidate switchover schemes with the same minimum number of switchovers for resolving the detected violation of the predefined threshold, selecting the switchover scheme to be used from the respective plurality of candidate switchover schemes using one or more of a time since a last switchover of the identified leader instances, for which the candidate switchover schemes define candidate switchovers, a size of the identified leader instances, for which the candidate switchover schemes define candidate switchovers, or an impact of the candidate switchovers defined by the candidate switchover schemes on other hosts of the plurality of hosts.

Thus, even in the case of candidate switchover schemes with the same minimum number of switchovers for resolving the detected violation of the predefined threshold, a switchover scheme to be used may be determined.

For example, the switchover scheme to be used, which is selected from the plurality of candidate switchover schemes, is a candidate switchover scheme with a longest time since the last switchover of the identified leader instances, for which a respective candidate switchover scheme defines candidate switchovers. The longest times since the last switchovers of a candidate switchover scheme may be a mean of the times for the individual candidate switchovers defined by the respective candidate switchover scheme, a total time of all the times for the individual candidate switchovers defined by the respective candidate switchover scheme, or the longest time included by the times for the individual candidate switchovers defined by the respective candidate switchover scheme.

For example, the switchover scheme to be used, which is selected from the plurality of candidate switchover schemes, is a candidate switchover scheme with a shortest time since the last switchover of the identified leader instances, for which a respective candidate switchover scheme defines candidate switchovers. The shortest times since the last switchovers of a candidate switchover scheme may be a mean of the times for the individual candidate switchovers defined by the respective candidate switchover scheme, a total time of all the times for the individual candidate switchovers defined by the respective candidate switchover scheme, or the shortest time included by the times for the individual candidate switchovers defined by the respective candidate switchover scheme.

For example, the switchover scheme to be used, which is selected from the plurality of candidate switchover schemes, is a candidate switchover scheme with a largest size of the identified leader instances, for which the respective candidate switchover scheme defines candidate switchovers. The largest size may be a mean of the sizes of the individual leader instances, for which a switchover is defined by the respective candidate switchover scheme, a total size of all the sizes of the individual leader instances, for which a switchover is defined by the respective candidate switchover scheme or the largest size time included by the sizes of the individual leader instances, for which a switchover is defined by the respective candidate switchover scheme.

For example, the switchover scheme to be used, which is selected from the plurality of candidate switchover schemes, is a candidate switchover scheme with a smallest size of the identified leader instances, for which the respective candidate switchover scheme defines candidate switchovers. The smallest size may be a mean of the sizes of the individual leader instances, for which a switchover is defined by the respective candidate switchover scheme, a total size of all the sizes of the individual leader instances, for which a switchover is defined by the respective candidate switchover scheme or a smallest size time included by the sizes of the individual leader instances, for which a switchover is defined by the respective candidate switchover scheme.

For example, the switchover scheme to be used, which is selected from the plurality of candidate switchover schemes, is a candidate switchover scheme defining candidate switchovers, from which no violation of the predefined threshold by another load state of another host of the plurality of hosts results.

For example, determining whether the candidate switchovers of a candidate switchover scheme resolve the detected violation of the predefined threshold, may include calculating expected metric values resulting from the potential switchovers of the respective candidate switchover scheme and checking, whether the expected metric values resolve the detected violation of the predefined threshold.

Using the expected metric values, the leader distribution managing component may, e.g., be able to estimate the effect of candidate switchovers defined by the candidate switchover scheme. For calculating the expected metric values, the leader distribution managing component may use the gathered metric values and, e.g., apply an extrapolation and/or an interpolation to the same.

For example, for each database instance, the leader instance and one or more replica instances of the respective database instance are distributed on different hosts of the plurality of hosts. Distributing the leader instance and one or more replica instances of a database instance on different hosts of the plurality of hosts may increase the availability of the respective database instance. In case a host fails or has problems, a single individual instance of the respective database instance may be affected. Thus, failure safety may be improved.

For illustrative purposes, an exemplary system may be considered. The exemplary system may, e.g., include four hosts, i.e., H1, H2, H3, and H4. These four hosts may, e.g., run three database instances, i.e., A, B, and C of a distributed database system. Each database instance may, e.g., include a leader instance, i.e., A.L, B.L, and C.L, as well as multiple replica instances, i.e., A.R1, B.R1, B.R2, C.R1, C.R2, and C.R3. To ensure a high availability, there may, e.g., be a constraint that the leader instances as well as the replica instances for each database instance must run on different hosts. A current system state, as known by the leader distribution managing component, may, e.g., be as follows:

- H1 (16 vCPU, 64GB RAM): A.L, B.L, C.R1;

- H2 (8 vCPU, 32GB RAM): C.L, A.R1;

- H3 (8 vCPU, 32GB RAM): B.R1, C.R2;

- H4 (16 vCPU, 32GB RAM): B.R2, C.R3.

A CPU utilization for each host may, e.g., be: H1: 82%: H2: 75%; H3: 50%; H4: 30%. The leader distribution managing component may be configured to monitor an 80% CPU utilization threshold as a predefined threshold. The leader distribution managing component may, e.g., gather the CPU utilization values of the hosts as metric values describing the load states of the hosts. When the leader distribution managing component detects that host H1's CPU utilization has reached 82% and thus violates the, i.e., exceeds the threshold, it may activate a switchover distribution algorithm to reduce the CPU utilization on host H1 below the threshold, i.e. resolve the detected violation of the predefined threshold.

A potential switchover scheme may be a list that includes one or more switchovers for one or more leader instances running on a host. Each switchover may define for one of the leader instances a switching of a leader role of the respective leader instance to a more replica instance of the respective leader instance; For example, the potential switchover scheme may define the switchovers: A.L <-> A.R1 and B.L <-> B.R1. This list of two switchovers may form a potential switchover scheme with a length of two. An execution of the switchovers defined by this potential switchover state would result in the following system state:

- H1: A.R1, B.R1, C.R1

- H2: C.L, A.L

- H3: B.L, C.R2

- H4: B.R2, C.R3

The leader distribution managing component may, e.g., begin by evaluating all potential switchover schemes with a length of one for switchovers of the leader instances running on host H1, that violate the predefined threshold, and check, if any of these potential switchover schemes with the length of one would bring the CPU utilization on host H1 below the predefined 80% threshold. If no suitable potential switchover scheme with the length of one may be found, the number of potential switchovers may be increased and potential switchover schemes with a length of two may be considered next. This order of evaluation following a successively increasing number of potential switchovers may ensure that a switchover scheme to be used for resolving the violation of the predefined threshold with a minimum number of switchovers may be found. Thus, when executing the switchovers defined by a found switchover scheme to be used, it may be ensured that only a minimum number of switchovers required for resolving the detected violation of the predefined threshold is performed. If no suitable switchover scheme for resolving the detected violation of the predefined threshold may be identified through this process, the leader distribution managing component may, e.g., raise an out-of-capacity alert. If multiple eligible candidate switchover schemes of the same length are found, which each are capable of resolving the detected violation of the predefined threshold, the leader distribution managing component may, e.g., consider a switchover history and select a candidate switchover scheme involving switchovers for instances that were switched over the longest time ago. Finally, the leader distribution managing component may control the execution of the switchovers defined by the switchover scheme to be used, e.g., in the order they appear in the respective switchover scheme to be used.

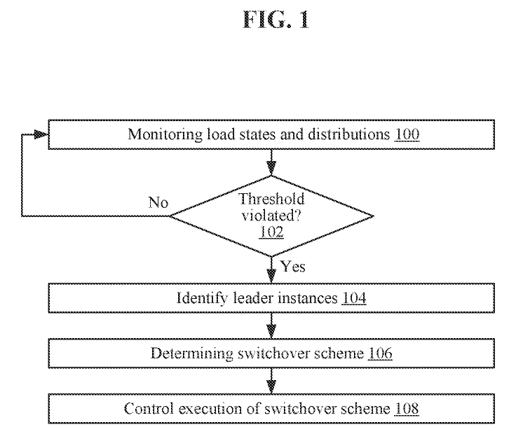

FIG. 1 is a flowchart of an exemplary method for controlling a distribution of leader instances of a distributed database system using a leader distribution managing component. The distributed database system is implemented on a plurality of hosts. The distributed database system includes a plurality of independent database instances. Each independent database instance of the plurality of independent database instances is implemented in a leader-follower configuration including one of the leader instances and one or more replica instances replicating the respective leader instance.

In block 100, the leader distribution managing component monitors load states of the hosts of the plurality of hosts and distributions of the plurality of independent database instances over the hosts of the plurality of hosts. The monitoring of the load states of the hosts includes gathering metric values descriptive of the respective load states. In block 102, the leader distribution managing component checks, using the metric values gathered in block 100, whether one of the load states of one of the hosts of the plurality of hosts violates a predefined threshold. In response to detecting a violation of the predefined threshold by one of the load states, the leader distribution managing component identifies leader instances of the plurality of independent database instances of the distributed database system running on the host with the load state violating the predefined threshold in block 104. In block 106, a switchover scheme to be used for resolving the detected violation of the predefined threshold is determined by the leader distribution managing component. The switchover scheme to be used defines a minimum number of one or more switchovers for the identified leader instances required for resolving the detected violation of the predefined threshold. Each switchover of the one or more switchovers defines for one of the identified leader instances a switching of a leader role of the respective identified leader instance to one of the one or more replica instances of the respective identified leader instance. In block 108, the leader distribution managing component controls an execution of the one or more switchovers defined by the switchover scheme to be used.

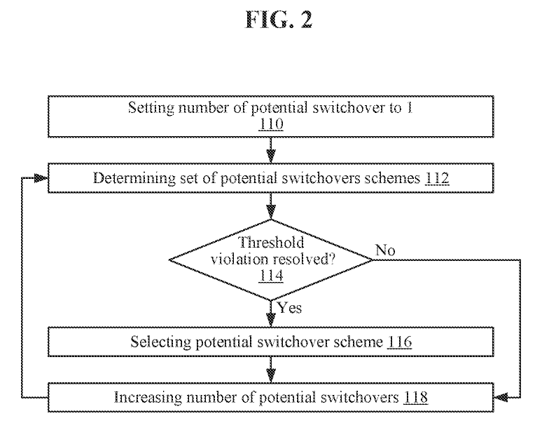

FIG. 2 is a flowchart illustrating an exemplary determination of a switchover scheme to be used, as it is, e.g., executed, in block 106 of FIG. 1. In block 110, the method may start with a number of potential switchovers for the leader instances identified running on a host violating a predefined threshold equal to one. Thus, a starting value for the number of potential switchovers may be set to one. In block 112, a set of potential switchover schemes is determined for the given number of potential switchovers. The set of potential switchover schemes includes a potential switchover scheme for each combination of potential switchovers of the respective number of switchovers. In block 114, it is determined for each potential switchover scheme of the set of potential switchover schemes determined in block 112, whether the potential switchovers of the respective potential switchover scheme resolve a detected violation of the predefined threshold. Determining whether the potential switchovers of the potential switchover schemes resolve the detected violation of the predefined threshold, may, e.g., include calculating expected metric values resulting from the potential switchovers of the respective potential switchover scheme and checking, whether the expected metric values resolve the detected violation of the predefined threshold.

In response to determining in block 114 that the potential switchovers of one of the potential switchover schemes resolve the detected violation of the predefined threshold, the respective potential switchover is selected as the switchover scheme to be used in block 116. In this case, the determination of the switchover scheme to be used for resolving the detected violation of the predefined threshold may be finished. Thus, the number of potential switchovers for the leader instances identified running on the host violating the predefined threshold may not be increased any further, i.e., an increase in the number of potential switchovers may be stopped. In response to determining in block 114 that none of the potential switchover schemes of the set of potential switchover schemes determined in block 112 may resolve the detected violation of the predefined threshold, the number of potential switchovers for the leader instances identified running on the host violating the predefined threshold is increased, e.g., by one, and the method is continued in block 118 using the increased number of potential switchovers for determining the set of potential switchover schemes in block 112. Thus, the potential switchovers for the identified leader instances may be successfully increasing until either a switchover scheme resolving the detected violation of the predefined threshold is found or a maximum number of potential switchovers is reached without finding a switchover scheme resolving the detected violation. The maximum number of potential switchovers may be given by a total number of leader instances identified to run on the host violating the predefined threshold. If the maximum number of potential switchovers is reached without finding a switchover scheme to resolve the detected violation, i.e., if no suitable switchover scheme for resolving the detected violation of the predefined threshold is found, the determination of a switchover scheme may be terminated and the leader distribution managing component may, e.g., raise an out-of-capacity alert. By successfully increasing the number of potential switchovers used for determining a switchover to be used for resolving the detected violation of the predefined threshold, it may be ensured that the determined includes a minimum number of switchovers required for resolving the violation.

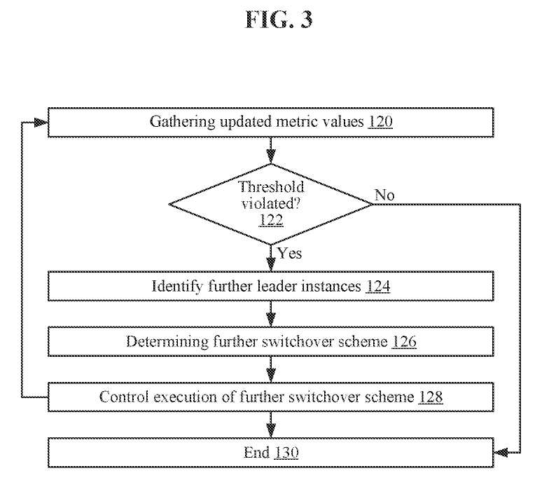

FIG. 3 is a flowchart of an exemplary method for an iterative resolving of violations of predefined thresholds. Using, e.g., the exemplary method of FIG. 1 a detected violation of a predefined threshold by one of the hosts of a plurality of hosts, on which a distributed database system is implemented, may be resolved. However, the resolving of the detected violation of the predefined threshold by the host may result in a violation of a predefined thresholds by another one of the hosts of the plurality of hosts. This may, e.g., be prevented by checking in block 106 of FIG. 1, when determining the switchover scheme to be used, that the determined switchover scheme does not result in any further violations of a predefined thresholds by another one of the hosts of the plurality of hosts, or an iterative method may be used as exemplarily outlined in FIG. 3.

In block 120, updated metric values descriptive of updated load states of the hosts of the plurality of hosts resulting from execution of the one or more switchovers defined by the switchover scheme to be used are gathered. The executed switchover scheme may, e.g., have been determined using the exemplary method of FIG. 1. Using the updated gathered metric values, it is checked in block 122, whether another one of the updated load states of one of the hosts of the plurality of hosts violates the predefined threshold or any other predefined threshold. In response to detecting a further violation of the predefined threshold or any other predefined threshold by another one of the updated load states, further leader instances of the plurality of independent database instances of the distributed database system running on the host with the updated load states violating of the predefined threshold are identified in block 124. In block 126 a further switchover scheme for resolving the detected further violation of the predefined threshold is determined. The further switchover scheme defines a minimum number of one or more further switchovers for the identified further leader instances required for resolving the detected further violation of the predefined threshold. Each switchover of the one or more further switchovers defines for one of the identified further leader instances a switching of a leader role of the respective identified further leader instance to one of the one or more replica instances of the respective identified further leader instance. In block 128, an execution of the one or more further switchovers defined by the further switchover scheme is controlled. After execution of the further switchover scheme, the method is continued in block 120 with gathering updated metric values descriptive of updated load states of the hosts of the plurality of hosts resulting from executing the one or more further switchovers in block 128 defined by the further switchover scheme. This iterative resolving violations of predefined thresholds may be continued until no further violations of any predefined thresholds are detected in block 122. In response to detecting no further violations of any predefined thresholds by any of the updated load states in block 122, the iterative method for resolving violations of predefined thresholds may terminate in block 130. After terminating the iterative method for resolving violations of predefined thresholds, e.g., the monitoring of load states of the hosts and distributions of the plurality of independent database instances over the hosts as defined in block 100 of the exemplary method of FIG. 1 may be continued.

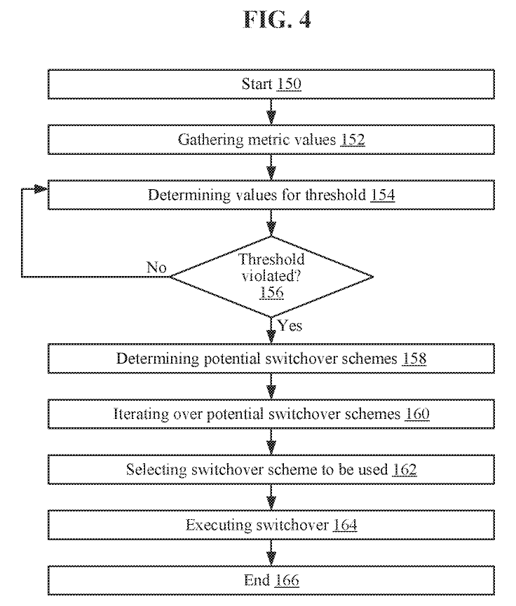

FIG. 4 is a flowchart of an exemplary method for controlling the distribution of leader instances of a distributed database system using a leader distribution managing component. The distributed database system is implemented on a plurality of hosts. The distributed database system includes a plurality of independent database instances. Each independent database instance of the plurality of independent database instances is implemented in a leader-follower configuration including one of the leader instances and one or more replica instances replicating the respective leader instance.

The method may start in block 150. In block 152 metric values on all hosts and all database instances of the database system may be gathered. These metric values may, e.g., be descriptive of one or more host system specific characteristics of the load states of the hosts. These metric values may, e.g., be descriptive of one or more database instance specific characteristics of the load states of the host. For each database instance, e.g., a host location of the leader instance as well as host locations of the replica instances may be determined. The leader distribution managing component may, e.g., keep track of host memory size and/or CPU size, since utilization calculations may depend on these absolute values. The leader distribution managing component may continuously monitor hosts and database instances to assess, whether predefined thresholds are violated.

The metric values gathered in block 152 may be used to determine in block 154 values to be checked for a violation of a predefined threshold. In block 156, it is checked, whether a predefined threshold is violated. For example, a set of predefined thresholds including one or more predefined thresholds may be checked for a violation. These thresholds may, e.g., be formulated as Boolean expressions using metric values of metrics accessible to the leader distribution managing component. Examples of such thresholds may, e.g., include 'Host CPU > 80%', 'Database number of connections > 100', 'Host Memory Size == 16Gi', or any valid combination thereof.

Upon detecting a violation of a threshold in block 156, the leader distribution managing component may endeavor to redistribute a minimum number of leader instances of the database instance to resolve the detected violation. If no violation of a threshold is detected in block 156, the leader distribution managing component may continue monitoring the hosts and database instances in block 150, e.g., by continuously gathering metric values.

In block 158 potential switchover schemes are determined. The determination of a switchover scheme to be used for resolving the detected violation of the predefined threshold may be executed iteratively as indicated in block 160. An exemplary method for such an iterative determining is shown in FIG. 2. In block 162, a switchover scheme to be used for resolving the detected violation of the predefined threshold is selected. In the redistribution process, the leader distribution managing component may, e.g., evaluate metric values gathered from hosts running replica instances associated with each leader instance responsible for violating the predefined threshold, i.e., running on the host violating the predefined threshold. The leader distribution managing component may, e.g., conduct a fresh threshold assessment using recalculated updated metric values, that would arise from switchovers, i.e., an appointing of replica instances as updated leader instances of database instances. After computing this for all potential switchovers concerning the affected host and, e.g., taking into account other database constraints, the leader distribution managing component may, e.g., select a switchover scheme with a minimum number of switchovers to be used for resolving the detected violation of the predefined threshold. In block 164, the leader distribution managing component may trigger the necessary switchovers of the leader instances as defined by the determined switchover scheme to be used. The method may end in block 166.

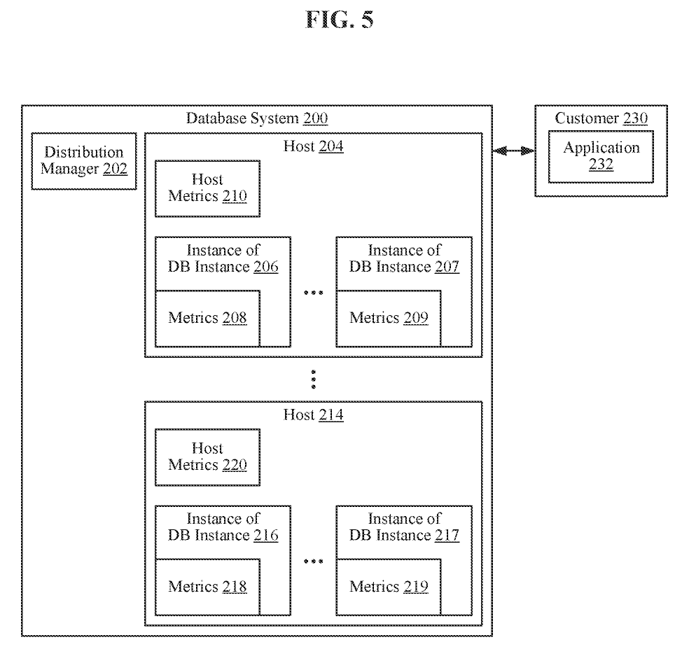

FIG. 5 is an exemplary distributed database 200 implemented on a plurality of hosts 204, 214. The distributed database system includes a plurality of independent database (DB) instances. Each independent database instance of the plurality of independent database instances includes a plurality of individual instances 206, 207, 216, 217 distributed over the hosts. For example, each independent database instance of the plurality of independent database instances, i.e. their individual instances 206, 207, 216, 217, is implemented in a leader-follower configuration including a leader instance and one or more replica instances replicating the respective leader instance. For example, the individual instances 206 of a first database instance of the database system 200 may be a leader instance running on a first host. This leader instance 206 may, e.g., be replicated by a replica instance 216 of the first database instance of the database system 200, which is running on another, second host 214. For example, the individual instance 217 of another, second database instance of the database system 200 may be a leader instance running on the second host 214. This leader instance 217 may, e.g., be replicated by a replica instance 207 of the second database instance of the database system 200, which is running on the first host. For example, for each database instance, the individual instances 206, 207, 216, 217, i.e., their leader instances and replica instances, may be distributed on different hosts 204, 214 of the plurality of hosts.

The database instances provided by the distributed database system 200 may be used by customers 230. For accessing a database instance, which is assigned to a customer 230, e.g., via a network, the customer may use an application 232. For example, the distributed database system 200 may provide a plurality of database instance in a multi-tenant environment.

A leader distribution managing component 202 (e.g., a leader distribution managing component) may be provided, which is configured for controlling a distribution of leader instances 206, 217 of the distributed database system 200. The leader distribution managing component 202 may, e.g., be configured to execute any of the methods of any of FIGS. 1 to 4. For example, the leader distribution managing component 202 is configured for monitoring of load states of the hosts 204, 214 of the plurality of hosts and distributions of the database instances, i.e., of the individual instances 206, 207, 216, 217, over the hosts 204, 214 of the plurality of hosts. The monitoring of the load states of the hosts 204, 214 may include gathering metric values descriptive of the respective load states. These metric values may, e.g., be values of host metrics 210, 220, i.e., metric values descriptive of host system-specific characteristics of the load states of the hosts 204, 214, and/or values of database metrics 208, 209, 218, 219, i.e., metric values descriptive of database instance specific characteristics of the load states of the hosts 204, 214.

Using the gathered metric values, the leader distribution managing component 202 may check whether one of the load states of one of the hosts 204, 214 of the plurality of hosts violates a predefined threshold. In response to detecting a violation of the predefined threshold by one of the load states, leader instances of the plurality of independent database instances of the distributed database system 200 running on the host with the load state violating the predefined threshold are identified by the leader distribution managing component 202. The leader distribution managing component 202 determines a switchover scheme to be used for resolving the detected violation of the predefined threshold. The switchover scheme to be used defines a minimum number of one or more switchovers for the identified leader instances required for resolving the detected violation of the predefined threshold. Each switchover of the one or more switchovers defines for one of the identified leader instances a switching of a leader role of the respective identified leader instance to one of the one or more replica instances of the respective identified leader instance. The leader distribution managing component 202 may control an execution of the one or more switchovers defined by the switchover scheme.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner that at least partially overlaps in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

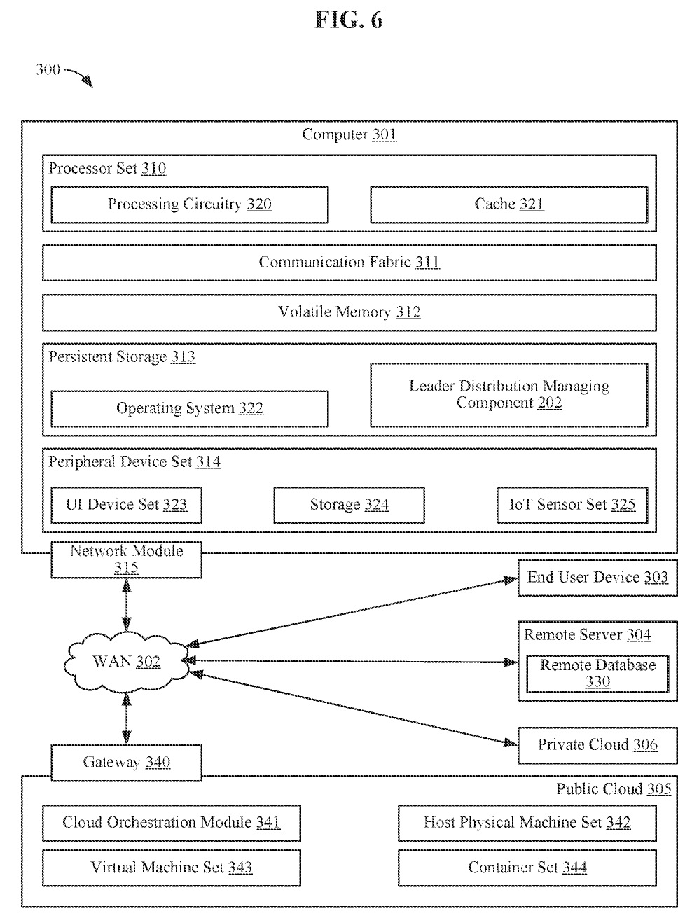

Referring now to FIG. 6, an illustrative computing environment 300 is depicted. Computing environment 300 contains an example of an environment for the execution of at least some of the computer code involved in performing the inventive methods, such as a leader distribution managing component 202. The leader distribution managing component 202 may, e.g., be configured to execute any of the methods of any of FIGS. 1 to 4. The leader distribution managing component 202 may be configured to monitor load states of the hosts of a plurality of hosts, on which a distributed database system is impended, and distributions of the plurality of independent database instances over the hosts of the plurality of hosts. The host may, e.g., be provided by a cloud, e.g., a public cloud 305. The leader distribution managing component 202 may, e.g., communicate with the hosts and/or the database instances implemented on the hosts via a network, e.g., via WAN 302. The monitoring of the load states of the hosts may include gathering metric values descriptive of the respective load states by the leader distribution managing component 202, e.g., via WAN 302. The distributed database system may be implemented on a plurality of hosts. The distributed database system may include a plurality of independent database instances. Each independent database instance of the plurality of independent database instances may be implemented in a leader-follower configuration including leader instances and one or more replica instances replicating the respective leader instance. Using the gathered metric values, the leader distribution managing component 202 may check, whether one of the load states of one of the hosts of the plurality of hosts violates a predefined threshold. In response to detecting a violation of the predefined threshold by one of the load states, leader instances of the plurality of independent database instances of the distributed database system running on the host with the load state violating the predefined threshold are identified by the leader distribution managing component 202. A switchover scheme to be used for resolving the detected violation of the predefined threshold is determined by the leader distribution managing component 202. The switchover scheme to be used defines a minimum number of one or more switchovers for the identified leader instances required for resolving the detected violation of the predefined threshold. Each switchover of the one or more switchovers defines for one of the identified leader instances a switching of a leader role of the respective identified leader instance to one of the one or more replica instances of the respective identified leader instance. The leader distribution managing component 202 may further control an execution of the one or more switchovers defined by the switchover scheme to be used, e.g., via WAN 302.

In addition to component 202, computing environment 300 includes, for example, computer 301, wide area network (WAN) 302, end user device (EUD) 303, remote server 304, public cloud 305, and private cloud 306. In this embodiment, computer 301 includes processor set 310 (including processing circuitry 320 and cache 321), communication fabric 311, volatile memory 312, persistent storage 313 (including operating system 322 and database system 200, as identified above), peripheral device set 314 (including user interface (UI) device set 323, storage 324, and Internet of Things (IoT) sensor set 325), and network module 315. Remote server 304 includes a remote database 330. Public cloud 305 includes gateway 340, cloud orchestration module 341, host physical machine set 342, virtual machine set 343, and container set 344.

COMPUTER 301 may take the form of a desktop computer, laptop computer, tablet computer, smartphone, smartwatch or other wearable computer, mainframe computer, quantum computer, or any other form of computer or mobile device now known or to be developed in the future that is capable of running a program, accessing a network or querying a database, such as remote database 330. As is well understood in the art of computer technology, and depending upon the technology, the performance of a computer-implemented method may be distributed among multiple computers and/or between multiple locations. On the other hand, in this presentation of computing environment 300, detailed discussion is focused on a single computer, specifically computer 301, to keep the presentation as simple as possible. Computer 301 may be located in a cloud, even though it is not shown in a cloud in FIG. 6. On the other hand, computer 301 is not required to be in a cloud except to any extent as may be affirmatively indicated.

PROCESSOR SET 310 includes one, or more, computer processors of any type now known or to be developed in the future. Processing circuitry 320 may be distributed over multiple packages, for example, multiple, coordinated integrated circuit chips. Processing circuitry 320 may implement multiple processor threads and/or multiple processor cores. Cache 321 is a memory that is located in the processor chip package(s) and is typically used for data or code that should be available for rapid access by the threads or cores running on processor set 310. Cache memories are typically organized into multiple levels depending upon relative proximity to the processing circuitry. Alternatively, some, or all, of the cache for the processor set may be located “off-chip.” In some computing environments, processor set 310 may be designed for working with qubits and performing quantum computing.

Computer-readable program instructions are typically loaded onto computer 301 to cause a series of operational steps to be performed by processor set 310 of computer 301 and thereby affect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 321 and the other storage media discussed below. The program instructions, and associated data, are accessed by processor set 310 to control and direct the performance of the inventive methods. In computing environment 300, at least some of the instructions for performing the inventive methods may be stored in database system 200 in persistent storage 313.

COMMUNICATION FABRIC 311 is the signal conduction path that allows the various components of computer 301 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

VOLATILE MEMORY 312 is any type of volatile memory now known or to be developed in the future. Examples include dynamic type random access memory (RAM) or static type RAM. Typically, volatile memory 312 is characterized by random access, but this is not required unless affirmatively indicated. In computer 301, the volatile memory 312 is located in a single package and is internal to computer 301, but, alternatively or additionally, the volatile memory may be distributed over multiple packages and/or located externally with respect to computer 301.

PERSISTENT STORAGE 313 is any form of non-volatile storage for computers that is now known or to be developed in the future. The non-volatility of this storage means that the stored data is maintained regardless of whether power is being supplied to computer 301 and/or directly to persistent storage 313. Persistent storage 313 may be a read-only memory (ROM), but typically at least a portion of the persistent storage allows writing of data, deletion of data, and re-writing of data. Some familiar forms of persistent storage include magnetic disks and solid-state storage devices. Operating system 322 may take several forms, such as various known proprietary operating systems or open-source Portable Operating System Interface-type operating systems that employ a kernel. The code included in database system 200 typically includes at least some of the computer code involved in performing the inventive methods.

PERIPHERAL DEVICE SET 314 includes the set of peripheral devices of computer 301. Data communication connections between the peripheral devices and the other components of computer 301 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 323 may include components such as a display screen, speaker, microphone, wearable devices (such as goggles and smartwatches), keyboard, mouse, printer, touchpad, game controllers, and haptic devices. Storage 324 is external storage, such as an external hard drive, or insertable storage, such as an SD card. Storage 324 may be persistent and/or volatile. In some embodiments, storage 324 may take the form of a quantum computing storage device for storing data in the form of qubits. In embodiments where computer 301 is required to have a large amount of storage (for example, where computer 301 locally stores and manages a large database) then this storage may be provided by peripheral storage devices designed for storing very large amounts of data, such as a storage area network (SAN) that is shared by multiple, geographically distributed computers. IoT sensor set 325 is made up of sensors that can be used in Internet of Things applications. For example, one sensor may be a thermometer, and another sensor may be a motion detector.

NETWORK MODULE 315 is the collection of computer software, hardware, and firmware that allows computer 301 to communicate with other computers through WAN 302. Network module 315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 315 are performed on the same physical hardware device. In other embodiments (for example, embodiments that utilize software-defined networking (SDN)), the control functions and the forwarding functions of network module 315 are performed on physically separate devices, such that the control functions manage several different network hardware devices. Computer-readable program instructions for performing the inventive methods can typically be downloaded to computer 301 from an external computer or external storage device through a network adapter card or network interface included in network module 315.

WAN 302 is any wide area network (for example, the internet) capable of communicating computer data over non-local distances by any technology for communicating computer data, now known or to be developed in the future. In some embodiments, the WAN 302 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

END USER DEVICE (EUD) 303 is any computer system that is used and controlled by an end user (for example, a customer of an enterprise that operates computer 301), and may take any of the forms discussed above in connection with computer 301. EUD 303 typically receives helpful and useful data from the operations of computer 301. For example, in a hypothetical case where computer 301 is designed to provide a recommendation to an end user, this recommendation would typically be communicated from network module 315 of computer 301 through WAN 302 to EUD 303. In this way, EUD 303 can display, or otherwise present, the recommendation to an end user. In some embodiments, EUD 303 may be a client device, such as a thin client, heavy client, mainframe computer, desktop computer, and so on.

REMOTE SERVER 304 is any computer system that serves at least some data and/or functionality to computer 301. Remote server 304 may be controlled and used by the same entity that operates computer 301. Remote server 304 represents the machine(s) that collect and store helpful and useful data for use by other computers, such as computer 301. For example, in a hypothetical case where computer 301 is designed and programmed to provide a recommendation based on historical data, then this historical data may be provided to computer 301 from remote database 330 of remote server 304.

PUBLIC CLOUD 305 is any computer system available for use by multiple entities that provides on-demand availability of computer system resources and/or other computer capabilities, especially data storage (cloud storage) and computing power, without direct active management by the user. Cloud computing typically leverages the sharing of resources to achieve coherence and economies of scale. The direct and active management of the computing resources of the public cloud 305 is performed by the computer hardware and/or software of cloud orchestration module 341. The computing resources provided by public cloud 305 are typically implemented by virtual computing environments that run on various computers making up the computers of host physical machine set 342, which is the universe of physical computers in and/or available to public cloud 305. The virtual computing environments (VCEs) typically take the form of virtual machines from virtual machine set 343 and/or containers from container set 344. It is understood that these VCEs may be stored as images and may be transferred among and between the various physical machine hosts, either as images or after the instantiation of the VCE. Cloud orchestration module 341 manages the transfer and storage of images, deploys new instantiations of VCEs, and manages active instantiations of VCE deployments. Gateway 340 is a collection of computer software, hardware, and firmware that allows public cloud 305 to communicate through WAN 302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 306 is similar to public cloud 305, except that the computing resources are only available for use by a single enterprise. While private cloud 306 is depicted as being in communication with WAN 302, in other embodiments a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 305 and private cloud 306 are both part of a larger hybrid cloud.

CLOUD COMPUTING SERVICES AND/OR MICROSERVICES (not separately shown in FIG. 6): private and public clouds are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the Internet. Cloud services facilitate the flow of user data from front-end clients (for example, user-side servers, tablets, desktops, and laptops), through the internet, to the provider’s systems, and back. In some embodiments, cloud services may be configured and orchestrated according to as “as a service” technology paradigm where something is being presented to an internal or external customer in the form of a cloud computing service. As-a-service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, if necessary, and virtual private networks.

It is to be understood that although this disclosure includes a detailed description of cloud computing, implementation of the teachings recited herein is not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows: On-demand self-service: a cloud consumer can unilaterally provision computing capabilities, such as server time and network storage, as needed automatically without requiring human interaction with the service’s provider. Broad network access: capabilities are available over a network and accessed through standard mechanisms that promote use by heterogeneous thin or thick client platforms (e.g., mobile phones, laptops, and PDAs). Resource pooling: the provider’s computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or data center).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time. Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service. Service Models are as follows: Software as a Service (SaaS): the capability provided to the consumer is to use the provider’s applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations. Infrastructure as a Service (IaaS): the capability provided to the consumer is to provision processing, storage, networks, and other fundamental computing resources where the consumer can deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows: Private cloud: the cloud infrastructure is operated solely for an organization. It may be managed by the organization or a third party and may exist on-premises or off-premises. Community cloud: the cloud infrastructure is shared by several organizations and supports a specific community that has shared concerns (e.g., mission, security requirements, policy, and compliance considerations). It may be managed by the organizations or a third party and may exist on-premises or off-premises. Public cloud: the cloud infrastructure is made available to the general public or a large industry group and is owned by an organization selling cloud services. Hybrid cloud: the cloud infrastructure is a composition of two or more clouds (private, community, or public) that remain unique entities but are bound together by standardized or proprietary technology that enables data and application portability (e.g., cloud bursting for load-balancing between clouds). A cloud computing environment is service-oriented with a focus on statelessness, low coupling, modularity, and semantic interoperability. At the heart of cloud computing is an infrastructure that includes a network of interconnected nodes.

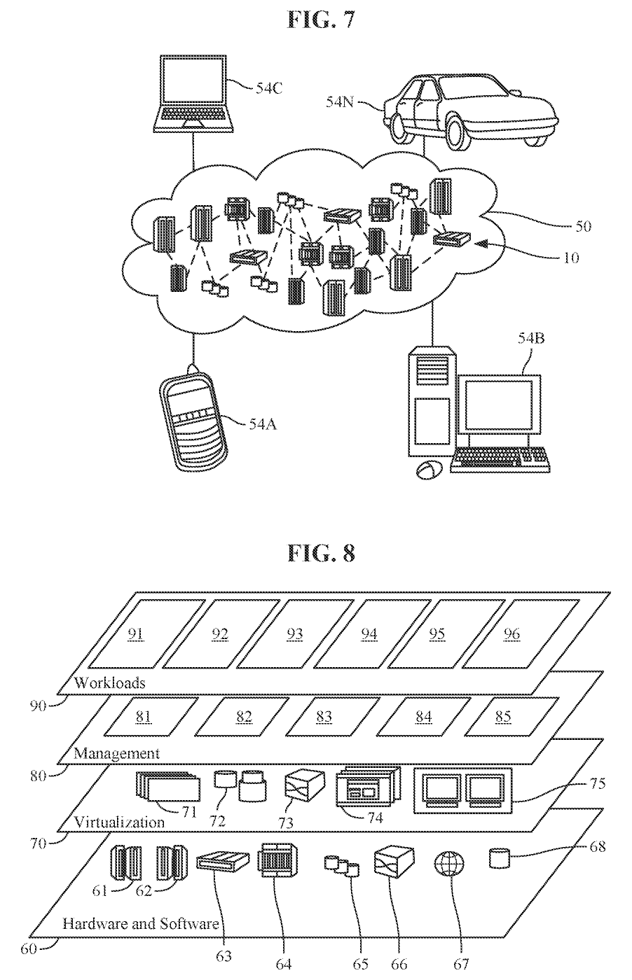

Referring now to FIG. 7, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. The one or more cloud computing nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms, and/or software as services for which a cloud consumer does not need to maintain resources on a local computing device. It is understood that the types of computing devices 54A-N shown in FIG. 7 are intended to be illustrative only and that the one or more cloud computing nodes 10 and cloud computing environment 50 can communicate with any type of computerized device over any type of network and/or network addressable connection (e.g., using a web browser).

Referring now to FIG. 8, a set of functional abstraction layers provided by the cloud computing environment 50 (FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions that may be provided from this layer include: mapping and navigation 91; software development and lifecycle management 92; virtual classroom education delivery 93; data analytics processing 94; transaction processing 95; and leader distribution managing 96 in accordance with any of the examples disclosed herein, e.g., using a leader distribution managing component as described with reference to any of FIGS. 5 and 6 and, e.g., configured to implement the methods described with reference to any of FIGS. 1 to 4.

Possible combination of features of examples described above may be the following:

Feature combination 1. A method for controlling a distribution of leader instances of a distributed database system using a leader distribution managing component, the distributed database system being implemented on a plurality of hosts, the distributed database system including a plurality of independent database instances, each independent database instance of the plurality of independent database instances being implemented in a leader-follower configuration including one of the leader instances and one or more replica instances replicating the respective leader instance, the method including by the leader distribution managing component: monitoring load states of hosts of the plurality of hosts and distributions of the plurality of independent database instances over the hosts of the plurality of hosts, the monitoring of the load states of the hosts including gathering metric values descriptive of the respective load states; checking, using the gathered metric values, whether one of the load states of one of the hosts of the plurality of hosts violates a predefined threshold; in response to detecting a violation of the predefined threshold by one of the load states, identifying leader instances of the plurality of independent database instances of the distributed database system running on the host with the load state violating the predefined threshold; determining a switchover scheme to be used for resolving the detected violation of the predefined threshold, the switchover scheme to be used defines a minimum number of one or more switchovers for the identified leader instances required for resolving the detected violation of the predefined threshold, each switchover of the one or more switchovers defining for one of the identified leader instances a switching of a leader role of the respective identified leader instance to one of the one or more replica instances of the respective identified leader instance; controlling an execution of the one or more switchovers defined by the switchover scheme to be used.

Feature combination 2. The method of feature combination 1, the metric values are descriptive of one or more host system specific characteristics of the load states of the hosts.

Feature combination 3. The method of feature combination 2, the metric values quantifying one or more of the following: an available capacity of a central processing unit of the respective host; and an available capacity of a memory of the respective host.

Feature combination 4. The method of any of the previous feature combinations, the metric values are descriptive of one or more database instance specific characteristics of the load states of the hosts.

Feature combination 5. The method of feature combination 4, the metric values describe one or more of the following: a number of database connections assigned to the database instances running on the respective host; a response time for database operations of the database instances running on the respective host; a rate of input and output operations of the database instances running on the respective host; a rate of database operations of the database instances running on the respective host.

Feature combination 6. The method of any of the previous feature combinations, the switchover scheme is determined to result in no violation of the predefined threshold by another load state of another host of the plurality of hosts.

Feature combination 7. The method of feature combination 6, the determining, that the switchover scheme to be used results in no violation of the predefined threshold by another load state of another host of the plurality of hosts, including calculating expected metric values resulting from the switchovers of the switchover scheme to be used and checking, that the expected metric values result in no violation of the predefined threshold by another load state of another host.

Feature combination 8. The method of any of the previous feature combinations, the determination of the switchover scheme to be used including: successfully increasing a number of potential switchovers for the identified leader instances, for each number of potential switchovers: determining a set of potential switchover schemes, the set of potential switchover schemes including a potential switchover scheme for each combination of potential switchover of the respective number of switchovers; determining for each potential switchover scheme of the set of potential switchover schemes, whether the potential switchovers of the respective potential switchover scheme resolve the detected violation of the predefined threshold; in response to determining that the potential switchovers of one of the potential switchover schemes resolve the detected violation of the predefined threshold, selecting the respective potential switchover as the switchover scheme to be used.

Feature combination 9. The method of feature combination 8, the determining, whether the potential switchovers of the potential switchover schemes resolve the detected violation of the predefined threshold including calculating expected metric values resulting from the potential switchovers of the respective potential switchover scheme and checking, whether the expected metric values resolve the detected violation of the predefined threshold.

Feature combination 10. The method of any of feature combinations 8 to 9, the method further including, in response to the determining that the potential switchovers of one of the potential switchover schemes resolve the detected violation of the predefined threshold, stopping the increasing of the number of potential switchovers.

Feature combination 11. The method of any of the previous feature combinations, the method further including: gathering updated metric values descriptive of updated load states of the hosts of the plurality of hosts resulting from the execution of the one or more switchovers defined by the switchover scheme to be used; checking, using the updated gathered metric values, whether another one of the updated load states of one of the hosts of the plurality of hosts violates the predefined threshold; in response to detecting a further violation of the predefined threshold by another one of the updated load states, identifying further leader instances of the plurality of independent database instances of the distributed database system running on the host with the updated load states violating of the predefined threshold; determining a further switchover scheme for resolving the detected further violation of the predefined threshold, the further switchover scheme defining a minimum number of one or more further switchovers for the identified further leader instances required for resolving the detected further violation of the predefined threshold, each switchover of the one or more further switchovers defining for one of the identified further leader instances a switching of a leader role of the respective identified further leader instance to one of the one or more replica instances of the respective identified further leader instance; controlling an execution of the one or more further switchovers defined by the further switchover scheme.

Feature combination 12. The method of any of the previous feature combinations, the determination of the switchover scheme to be used further including, in response to determining a plurality of candidate switchover schemes with the same minimum number of switchovers for resolving the detected violation of the predefined threshold, selecting the switchover scheme to be used from the respective plurality of candidate switchover schemes using one or more of a time since a last switchover of the identified leader instances, for which the candidate switchover schemes define candidate switchovers, a size of the identified leader instances, for which the candidate switchover schemes define candidate switchovers, or an impact of the candidate switchovers defined by the candidate switchover schemes on other hosts of the plurality of hosts.

Feature combination 13. The method of feature combination 12, the switchover scheme to be used, which is selected from the plurality of candidate switchover schemes, is a candidate switchover scheme with longest times since the last switchover of the identified leader instances, for which the respective candidate switchover scheme defines candidate switchovers.

Feature combination 14. The method of feature combination 12, the switchover scheme to be used, which is selected from the plurality of candidate switchover schemes, is a candidate switchover scheme with shortest times since the last switchover of the identified leader instances, for which the respective candidate switchover scheme defines candidate switchovers.

Feature combination 15. The method of any of feature combinations 12 to 14, the switchover scheme to be used, which is selected from the plurality of candidate switchover schemes, is a candidate switchover scheme with a largest size of the identified leader instances, for which the respective candidate switchover scheme defines candidate switchovers.

Feature combination 16. The method of any of feature combinations 12 to 14, the switchover scheme to be used, which is selected from the plurality of candidate switchover schemes, is a candidate switchover scheme with a smallest size of the identified leader instances, for which the respective candidate switchover scheme defines candidate switchovers.

Feature combination 17. The method of any of feature combinations 12 to 16, the switchover scheme to be used, which is selected from the plurality of candidate switchover schemes, is a candidate switchover scheme defining candidate switchovers, from which no violation of the predefined threshold by another load state of another host of the plurality of hosts results.

Feature combination 18. The method of any of the previous feature combinations, for each database instance, the leader instance, and one or more replica instances of the respective database instance being distributed on different hosts of the plurality of hosts.

Feature combination 19. A computer program product for controlling a distribution of leader instances of a distributed database system using a leader distribution managing component, the distributed database system being implemented on a plurality of hosts, the distributed database system including a plurality of independent database instances, each independent database instance of the plurality of independent database instances being implemented in a leader-follower configuration including one of the leader instances and one or more replica instances replicating the respective leader instance, the computer program product including a non-transitory computer-readable storage medium having computer-readable program code embodied therewith, the program code is configured to implement the leader distribution managing component, execution of the computer-readable program code by a processing unit of a computing device causing the leader distribution managing component to execute a method according to any of the previous feature combinations.

Feature combination 20. A computing device for controlling a distribution of leader instances of a distributed database system using a leader distribution managing component, the distributed database system is implemented on a plurality of hosts, the distributed database system including a plurality of independent database instances, each independent database instance of the plurality of independent database instances being implemented in a leader-follower configuration including one of the leader instances and one or more replica instances replicating the respective leader instance, the computing device including a processing unit and a memory unit with computer-readable program code embodied therewith, the program code is configured to implement the leader distribution managing component, execution of the computer-readable program code by the processing unit causing the leader distribution managing component to execute a method according to any of the previous feature combinations.

What is claimed is:

1. A method for controlling a distribution of leader instances of a distributed database system using a leader distribution managing component, the distributed database system being implemented on a plurality of hosts, the distributed database system comprising a plurality of independent database instances, each independent database instance of the plurality of independent database instances being implemented in a leader-follower configuration comprising one of the leader instances and one or more replica instances replicating the respective leader instance, the method comprising by the leader distribution managing component:
configuring, monitoring load states of hosts of the plurality of hosts, and distributions of the plurality of independent database instances over the hosts of the plurality of hosts, the monitoring of the load states of the hosts comprising gathering metric values descriptive of the respective load states;
checking, using the gathered metric values, whether one of the load states of one of the hosts of the plurality of hosts violates a predefined threshold;
in response to detecting a violation of the predefined threshold by one of the load states, identifying leader instances of the plurality of independent database instances of the distributed database system running on the host with the load state violating the predefined threshold;
determining a switchover scheme to be used for resolving the detected violation of the predefined threshold, the switchover scheme to be used defines a minimum number of one or more switchovers for the identified leader instances required for resolving the detected violation of the predefined threshold, each switchover of the one or more switchovers defining for one of the identified leader instances a switching of a leader role of the respective identified leader instance to one of the one or more replica instances of the respective identified leader instance; and
controlling an execution of the one or more switchovers defined by the switchover scheme to be used.

2. The method of claim 1, wherein the metric values are descriptive of one or more host system specific characteristics of the load states of the hosts.

3. The method of claim 2, wherein the metric values quantify one or more of an available capacity of a central processing unit of a respective host, or an available capacity of a memory of the respective host.

4. The method of claim 1, wherein the metric values are descriptive of one or more database instance specific characteristics of the load states of the hosts.

5. The method of claim 4, wherein the metric values describe one or more of a number of database connections assigned to the database instance running on the respective host, a response time for database operations of the database instance running on the respective host, a rate of input and output operations of the database instance running on the respective host, or a rate of database operations of the database instance running on the respective host.

6. The method of claim 1, wherein the switchover scheme to be used is determined to result in no violation of the predefined threshold by another load state of another host of the plurality of hosts.

7. The method of claim 6, wherein determining, that the switchover scheme to be used results in no violation of the predefined threshold by another load state of another host of the plurality of hosts, comprising calculating expected metric values resulting from the switchovers of the switchover scheme to be used and checking, that the expected metric values result in no violation of the predefined threshold by another load state of another host.

8. The method of claim 1, wherein determining the switchover scheme to be used comprising:
increasing a number of potential switchovers for the identified leader instances,
for each number of potential switchovers:
determining a set of potential switchover schemes, the set of potential switchover schemes comprising a potential switchover scheme for each combination of potential switchover of the respective number of switchovers;
determining for each potential switchover scheme of the set of potential switchover schemes, whether the potential switchovers of the respective potential switchover scheme resolve the detected violation of the predefined threshold; and
in response to determining that the potential switchovers of one of the potential switchover schemes resolve the detected violation of the predefined threshold, selecting the respective potential switchover as the switchover scheme to be used.

9. The method of claim 8, wherein determining, whether the potential switchovers of the the potential switchover schemes resolve the detected violation of the predefined threshold comprising calculating expected metric values resulting from the potential switchovers of the respective potential switchover scheme and checking, whether the expected metric values resolve the detected violation of the predefined threshold.

10. The method of claim 8, the method further comprising, in response to the determining that the potential switchovers of one of the potential switchover schemes resolve the detected violation of the predefined threshold, stopping the increasing of the number of potential switchovers.

11. The method of claim 1, wherein the method further comprising:
gathering updated metric values descriptive of updated load states of the hosts of the plurality of hosts resulting from execution of the one or more switchovers defined by the switchover scheme to be used;
checking, using the updated gathered metric values, whether another one of the updated load states of one of the hosts of the plurality of hosts violates the predefined threshold;
in response to detecting a further violation of the predefined threshold by another one of the updated load states, identifying further leader instances of the database instance of the distributed database system running on a host with the updated load states violating of the predefined threshold;
determining a further switchover scheme for resolving the detected further violation of the predefined threshold, the further switchover scheme defining a minimum number of one or more further switchovers for the identified further leader instances required for resolving the detected further violation of the predefined threshold, each switchover of the one or more further switchovers defining for one of the identified further leader instances a switching of a leader role of a respective identified further leader instance to one of the one or more replica instances of the respective identified further leader instance; and
controlling an execution of the one or more further switchovers defined by the further switchover scheme.

12. The method of claim 1, wherein determining the switchover scheme to be used further comprising, in response to determining a plurality of candidate switchover schemes with a same minimum number of switchovers for resolving the detected violation of the predefined threshold, selecting the switchover scheme to be used from the respective plurality of candidate switchover schemes using one or more of a time since a last switchover of the identified leader instances, for which the candidate switchover schemes define candidate switchovers, a size of the identified leader instances, for which the candidate switchover schemes define candidate switchovers, or an impact of the candidate switchovers defined by the candidate switchover schemes on other hosts of the plurality of hosts.

13. The method of claim 12, wherein the switchover scheme to be used, which is selected from the plurality of candidate switchover schemes, is a candidate switchover scheme with a longest time since the last switchover of the identified leader instances, for which a respective candidate switchover scheme defines candidate switchovers.

14. The method of claim 12, wherein the switchover scheme to be used, which is selected from the plurality of candidate switchover schemes, is a candidate switchover scheme with a shortest times since the last switchover of the identified leader instances, for which a respective candidate switchover scheme defines candidate switchovers.

15. The method of claim 12, wherein the switchover scheme to be used, which is selected from the plurality of candidate switchover schemes, is a candidate switchover scheme with a largest size of the identified leader instances, for which a respective candidate switchover scheme defines candidate switchovers.

16. The method of claim 12, wherein the switchover scheme to be used, which is selected from the plurality of candidate switchover schemes, is a candidate switchover scheme with a smallest size of the identified leader instances, for which a respective candidate switchover scheme defines candidate switchovers.

17. The method of claim 12, wherein the switchover scheme to be used, which is selected from the plurality of candidate switchover schemes, being a candidate switchover scheme defining candidate switchovers, from which no violation of the predefined threshold by another load state of another host of the plurality of hosts results.

18. The method of claim 12, wherein for each database instance, a leader instance and one or more replica instances of a respective database instance are distributed on different hosts of the plurality of hosts.

19. A computer program product for controlling a distribution of leader instances of a distributed database system using a leader distribution managing component, the distributed database system being implemented on a plurality of hosts, the distributed database system comprising a plurality of independent database instances, each independent database instance of the plurality of independent database instances being implemented in a leader-follower configuration comprising one of the leader instances and one or more replica instances replicating the respective leader instance,
the computer program product comprising a non-transitory computer-readable storage medium having computer-readable program code embodied therewith, the program code is configured to implement the leader distribution managing component,
execution of the computer-readable program code by a processing unit of a computing device causing the leader distribution managing component to:
monitor load states of hosts of the plurality of hosts and distributions of the plurality of independent database instances over the hosts of the plurality of hosts, the monitoring of the load states of the hosts comprising gathering metric values descriptive of the respective load states;
check, using the gathered metric values, whether one of the load states of one of the hosts of the plurality of hosts violates a predefined threshold;
in response to detecting a violation of the predefined threshold by one of the load states, identify leader instances of the plurality of independent database instances of the distributed database system running on the host with the load state violating of the predefined threshold;
determine a switchover scheme to be used for resolving the detected violation of the predefined threshold, the switchover scheme to be used defines a minimum number of one or more switchovers for the identified leader instances required for resolving the detected violation of the predefined threshold, each switchover of the one or more switchovers defining for one of the identified leader instances a switching of a leader role of the respective identified leader instance to one of the one or more replica instances of the respective identified leader instance; and
control an execution of the one or more switchovers defined by the switchover scheme to be used.

20. A computing device for controlling a distribution of leader instances of a distributed database system using a leader distribution managing component, the distributed database system being implemented on a plurality of hosts, the distributed database system comprising a plurality of independent database instances, each independent database instance of the plurality of independent database instances being implemented in a leader-follower configuration comprising one of the leader instances and one or more replica instances replicating the respective leader instance,
the computing device comprising a processing unit and a memory unit with computer-readable program code embodied therewith, the program code is configured to implement the leader distribution managing component, execution of the computer-readable program code by the processing unit causing the leader distribution managing component to:
monitor load states of hosts of the plurality of hosts and distributions of the plurality of independent database instances over the hosts of the plurality of hosts, the monitoring of the load states of the hosts comprising gathering metric values descriptive of the respective load states;
check, using the gathered metric values, whether one of the load states of one of the hosts of the plurality of hosts violates a predefined threshold;
in response to detecting a violation of the predefined threshold by one of the load states, identify leader instances of the database instance of a plurality of independent distributed database systems running on the host with the load state violating the predefined threshold;
determine a switchover scheme to be used for resolving the detected violation of the predefined threshold, the switchover scheme to be used defines a minimum number of one or more switchovers for the identified leader instances required for resolving the detected violation of the predefined threshold, each of the one or more switchovers defining for one of the identified leader instances a switching of a leader role of the respective identified leader instance to one of the one or more replica instances of the respective identified leader instance; and
control an execution of the one or more switchovers defined by the switchover scheme to be used.
